(19) United States
(12) Patent Application Publication
(10) Pub. No.: US 2019/0372939 A1
(43) Pub. Date: Dec. 5, 2019

(54) MALICIOUS NETWORK ACTIVITY MITIGATION

(71) Applicant: NOKIA SOLUTIONS AND NETWORKS OY, Espoo (FI)

(72) Inventors: Aapo KALLIOLA, Espoo (FI); Ian Justin OLIVER, Soderkulla (FI); Yoan Jean Claude MICHE, Espoo (FI); Orestis KOSTAKIS, Espoo (FI)

(21) Appl. No.: 16/334,142

(22) PCT Filed: Sep. 16, 2016
(86) PCT No.: PCT/EP2016/072021

§ 371 Date: Mar. 18, 2019

(51) Int. Cl. H04L 29/06; H04L 12/26; H04L 12/46

(52) U.S. Cl. CPC H04L 63/0272; H04L 43/026; H04L 43/062; H04L 45/64; H04L 63/1408; H04L 12/4641; H04L 63/20

(57) ABSTRACT

There are provided measures for malicious network activity mitigation. Such measures exemplarily comprise determining a boundary enclosing a first group of target virtual network functions including at least one target virtual network function, identifying, on the basis of said boundary, a first group of communication paths between said first group of target virtual network functions and respective network entities outside said boundary, said first group of communication paths including a first communication path, and initiating setup of a first wrapper virtual network function corresponding to said first communication path, said first wrapper virtual network function monitoring network traffic on said first communication path.

### FIELD

The present invention relates to malicious network activity mitigation. More specifically, the present invention exemplarily relates to measures (including methods, apparatuses and computer program products) for realizing malicious network activity mitigation.

### BACKGROUND

The present specification generally relates to mitigation and prevention of malicious network activity in a cloud environment. Such cloud environment consists of a number of virtual network functions (VNFs) which are interconnected and externally connected using software defined networking (SDN) technologies. The present invention particularly relates to mitigation and prevention of malicious network activity by means of SDN-aware VNF wrappers.

Deploying traffic analyzer VNFs in an SDN network is a flexible technique for traffic analysis. Suspicious traffic (traffic detected as being suspicious as a result of the traffic analysis) can be directed to network-internal or external traffic scrubbing devices for more extensive analysis. However, respective proprietary approaches are not native to the cloud environment.

Further, there are SDN debugging tools known, which are geared towards generic network troubleshooting.

However, in a cloud environment consisting of a number of virtual network functions (VNFs), traffic analysis and attack mitigation in relation to groups of VNFs with SDN interconnects is a non-trivial problem.

Namely, due to the inherent logical connections between VNFs and their traffic, a comprehensive but efficient analysis of the traffic requires intimate domain knowledge from the operator deploying the traffic analyzers.

In addition to simple analysis, there is also a need for a mitigation step, which is commonly handled by separate devices scrubbing the traffic. This common approach potentially leads to scaling inefficiencies, as the traffic scrubbers typically have a fixed capacity regardless of whether there is an attack going on or not.

Prior art which relates to this field can be found in document CN 104 753 951 A, describing a network traffic security platform on a high level. This document is silent with respect to VNF environment specific features and does not provide any specific means of implementing the monitoring deployment, monitoring method or mitigation or dynamic capability scaling in relation to a group of VNFs.

Further prior art which relates to this field can be found in document CN 104 506 507 A, describing a honey net system and method for SDN, in which multiple modules work together to perform intrusion detection. The system described in this document uses packet analysis in an intrusion detection system for directing incoming traffic to a custom-built honey net, if the traffic is deemed malicious. This document is silent with respect to VNF environment specific features as well.

Hence, the problem arises that VNF traffic analysis in relation to mitigation prevention/avoidance requires high efforts regarding domain knowledge and regarding needed resources.

Hence, there is a need to provide for malicious network activity mitigation. In particular, there is a need for measures enabling network activity monitoring and malice mitigation in an efficient manner.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method in a software defined networking based network, comprising determining a boundary enclosing a first group of target virtual network functions including at least one target virtual network function, identifying, on the basis of said boundary, a first group of communication paths between said first group of target virtual network functions and respective network entities outside said boundary, said first group of communication paths including a first communication path, and initiating setup of a first wrapper virtual network function corresponding to said first communication path, said first wrapper virtual network function monitoring network traffic on said first communication path.

According to an exemplary aspect of the present invention, there is provided an apparatus in a software defined networking based network, the apparatus comprising determining circuitry configured to determine a boundary enclosing a first group of target virtual network functions including at least one target virtual network function, identifying circuitry configured to identify, on the basis of said boundary, a first group of communication paths between said first group of target virtual network functions and respective network entities outside said boundary, said first group of communication paths including a first communication path, and initiating circuitry configured to initiate setup of a first wrapper virtual network function corresponding to said first communication path, said first wrapper virtual network function monitoring network traffic on said first communication path.

According to an exemplary aspect of the present invention, there is provided an apparatus in a software defined networking based network, the apparatus comprising at least one processor, at least one memory including computer program code, and at least one interface configured for communication with at least another apparatus, the at least one processor, with the at least one memory and the computer program code, being configured to cause the apparatus to perform determining a boundary enclosing a first group of target virtual network functions including at least one target virtual network function, identifying, on the basis of said boundary, a first group of communication paths between said first group of target virtual network functions and respective network entities outside said boundary, said first group of communication paths including a first communication path, and initiating setup of a first wrapper virtual network function corresponding to said first communication path, said first wrapper virtual network function monitoring network traffic on said first communication path.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient wrapping of network communications interfaces of groups of VNFs at runtime, definition, setting up, running, modifying and/or shutting down of respective measurements, to thereby solve at least part of the problems and drawbacks identified in relation to the prior art. Further, any one of the above aspects enables an efficient provision of dynamic wrapper capability scaling and/or a high-level semi-autonomous view into VNF traffic analysis and attack mitigation.

By way of exemplary embodiments of the present invention, there is provided malicious network activity mitigation. More specifically, by way of exemplary embodiments of the present invention, there are provided measures and mechanisms for realizing malicious network activity mitigation.

Thus, improvement is achieved by methods, apparatuses and computer program products enabling/realizing malicious network activity mitigation.

### BRIEF DESCRIPTION OF THE DRAWINGS

In the following, the present invention will be described in greater detail by way of non-limiting examples with reference to the accompanying drawings, in which

FIG. 1 is a block diagram illustrating an apparatus according to exemplary embodiments of the present invention,

FIG. 2 is a schematic diagram of a procedure according to exemplary embodiments of the present invention,

FIG. 3 shows a schematic diagram of an example of a system environment according to exemplary embodiments of the present invention,

FIG. 4 shows a schematic diagram of an example of a system environment according to exemplary embodiments of the present invention,

FIG. 5 shows a schematic diagram of an example of a system environment according to exemplary embodiments of the present invention,

FIG. 6 shows a schematic diagram of an example of a system environment according to exemplary embodiments of the present invention,

FIG. 7 shows a schematic diagram of an example of a system environment according to exemplary embodiments of the present invention,

FIG. 8 shows a schematic diagram of an example of a system architecture utilized according to exemplary embodiments of the present invention,

FIG. 9 shows a schematic diagram of signaling sequences according to exemplary embodiments of the present invention,

FIG. 10 shows a schematic diagram of signaling sequences according to exemplary embodiments of the present invention,

FIG. 11 shows a schematic diagram of signaling sequences according to exemplary embodiments of the present invention,

FIG. 12 shows a schematic diagram of signaling sequences according to exemplary embodiments of the present invention,

FIG. 13 is a block diagram illustrating an apparatus according to exemplary embodiments of the present invention, and

FIG. 14 is a block diagram alternatively illustrating apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP or ETSI specifications being used as non-limiting examples for certain exemplary network configurations and deployments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) malicious network activity mitigation.

In particular, according to exemplary embodiments of the present invention, means for effecting mitigation and prevention of further malicious network activity related to the constituent VNFs by “wrapping” said VNFs in transparent network-aware security functionality is provided.

In general, according to exemplary embodiments of the present invention, definition, start-up procedure, runtime operation and shutdown procedure of a logical wrapper entity is provided for, which can be placed around a single VNF or a group of interconnected VNFs. Once in operation, the wrapper entity analyses network traffic on the ingress and egress interfaces of the enclosed VNF or group of VNFs, and potentially, on detecting malicious activity, blocks the malicious activity.

According to exemplary embodiments of the present invention, such logical wrapper entity can enclose a single VNF or can enclose a group of (interconnected) VNFs.

When enclosing a single VNF, all of the incoming and outgoing network traffic of this single VNF needs to be monitored and acted upon if necessary.

When enclosing multiple VNFs, according to exemplary embodiments of the present invention, a modified approach is utilized. Namely, due to the network interconnects between these VNFs, which together effectively form a larger aggregate VNF, it would waste lots of network and computing resources to monitor all the interfaces.

In particular, according to exemplary embodiments of the present invention, the important monitoring is considered as only happen on an outer surface of this enclosed VNF communications space.

Nevertheless, in addition to the monitoring points at the edge of the wrapped area, according to further exemplary embodiments of the present invention, it is also possible to define additional monitoring points within the wrapper, i.e. within the wrapped area, i.e. within the boundary defined by the wrapped area.

This multi-VNF case can extend from simple chain-connected VNF aggregates to branching VNF interconnect architectures with multiple input and output connections.

Regarding instantiation of wrapping around a VNF or a group of VNFs, according to exemplary embodiments of the present invention, there are two different cases considered.

Namely, on the one hand, the enclosed VNFs may be already running.

Further, on the other hand, the enclosed VNFs may be already defined to be wrapped prior to their instantiation.

According to exemplary embodiments of the present invention, both cases may be treated differently.

Namely, in the latter case that the VNFs are not yet instantiated, there is the implicit stipulation that the VNFs are to be protected by the wrapper at all times. This means that according to exemplary embodiments of the present invention the wrapper must be ready for handling all traffic right from the point of wrapped VNF instantiation until the end of the VNF lifecycle

Further, in the former case that VNFs are wrapped only after their startup, according to exemplary embodiments of the present invention, the focus is on the transparency of the wrapper instantiation around the VNFs, where an important concern is the non-interruption of the running VNFs' communications.

According to exemplary embodiments, the wrapping entity has capabilities ranging from, but not limited to, simple traffic analysis via deep packet inspection (DPI) to malware analysis. The set of active capabilities can be adjusted dynamically, e.g., traffic analyzer may request for DPI capability after detecting suspicious traffic patterns. Capabilities can also be downgraded dynamically. For example, if the DPI observes no need for its existence it can request to be terminated. This dynamic feature set adjustment leads to near-optimal use of resources without compromising the maximum capability of the mitigation mechanism.

According to exemplary embodiments, the wrapper is a set of functionalities, which may be embodied by an apparatus or a set of apparatuses and which has at least the following properties.

Namely, when the wrapper is not intercepting or modifying traffic on purpose, according to exemplary embodiments of the present invention, it is invisible on the user plane (transparency).

Further, when the wrapped VNFs are terminated, according to exemplary embodiments of the present invention, the wrapper is also terminated (lifecycle linkage with wrapped VNFs). The lifecycle linkage can also be two-directional (wrapped VNFs are terminated on wrapper termination), if the VNFs are not to be run without the protection of the wrapper.

Further, unless otherwise defined by the above-mentioned lifecycle linkage, on termination or possible failure of the wrapper, according to exemplary embodiments of the present invention, communications are gracefully returned to previous un-wrapped state and the availability of enclosed VNFs is maintained (reversible instantiation and communications rule modification).

Further, according to exemplary embodiments of the present invention, only an entity responsible for wrapper management can modify wrapper-related communications rules (non-tamperability of wrapper-related communication rules in the underlying network).

Finally, according to exemplary embodiments of the present invention, a trusted wrapper is aware of its own integrity and the integrity of the wrapper-related communications rules and of possible changes to these (integrity).

In addition to mitigating malicious network traffic at the boundary of the wrapped VNF area, the measures according to exemplary embodiments of the present invention (e.g. a system, a method) can also mitigate volumetric denial of service (DoS) or distributed denial of service (DDoS) attack traffic directed at the protected (wrapped) part of the network elsewhere in the network, preferably already at the edge of the SDN domain. Complementary techniques such as network slicing can be included in the mitigation for ensuring that benign traffic entering and exiting the protected area passes in and out of the controlled network without packet drops. This mechanism requires a view and control of network traffic beyond the wrapper VNFs, which, according to exemplary embodiments of the present invention, can be achieved by using network traffic sampling and dynamic control of the underlying SDN network.

In other words, according to exemplary embodiments of the present invention, the following features and characteristics are provided.

Namely, VNFs may be characterized and/or classified as wrapped and wrapping entities.

Further, traffic analysis focused on defined logical blocks (VNF aggregates) in the network are provided instead of generic SDN network traffic analytics.

Further, the VNF start-up procedure may be modified in order to facilitate the necessary network traffic flow path analysis and making the wrapping boundary decision.

Further, the surface of the wrapping boundary may be dynamically adjusted.

In this regard, it is noted that the measures according to the present invention are open to standardizable implementation context.

Further wrapper instantiation and capability adjustment may be effected dynamically.

Further, wrapping VNF instantiation location may be optimized.

Further, malicious traffic prevention/analysis may be performed within the wrapping entity instead of (a) separate device(s).

Further, specific connections (from the wrapping entity) to wrapper management (e.g. cloud security director MANO (management and orchestration)/VNFI (virtual network function interface)) may be provided.

Further, the capabilities to monitor, analyze and prevent attacks originating both from external sources and from the enclosed VNF aggregate are provided.

Further, support for manual boundary definition and automatic boundary deduction based on monitored VNF connectivity graph may be provided.

Further, mitigation of volumetric traffic attacks directed at or originating from the wrapped VNFs may be provided by using the functionality and properties of the underlying SDN network.

Further, the wrapper functionality may be transparent.

Still further, the wrapper and wrapped VNFs may be lifecycle-linked.

Further, the instantiation and communications rule modification of a wrapper functionality may be reversible.

Furthermore, wrapper-related communications rules may be not temperable.

Finally integrity protection of a trusted wrapper may be provided.

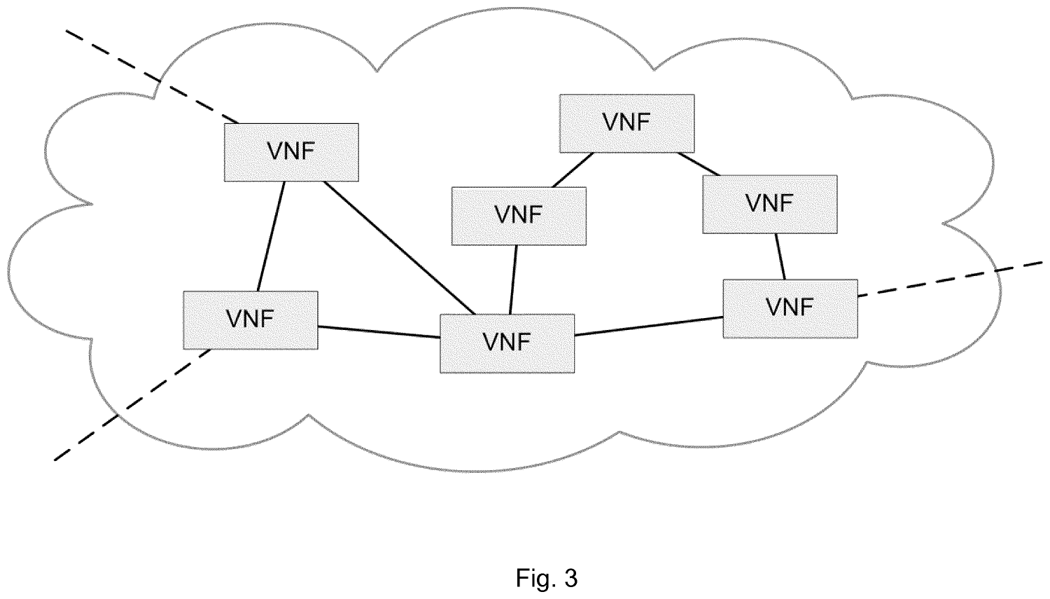

An exemplary scenario in which the present invention is applied is explained with reference to FIGS. 3 to 8.

Here, FIGS. 3 to 7 respectively show schematic diagrams of system environments according to exemplary embodiments of the present invention.

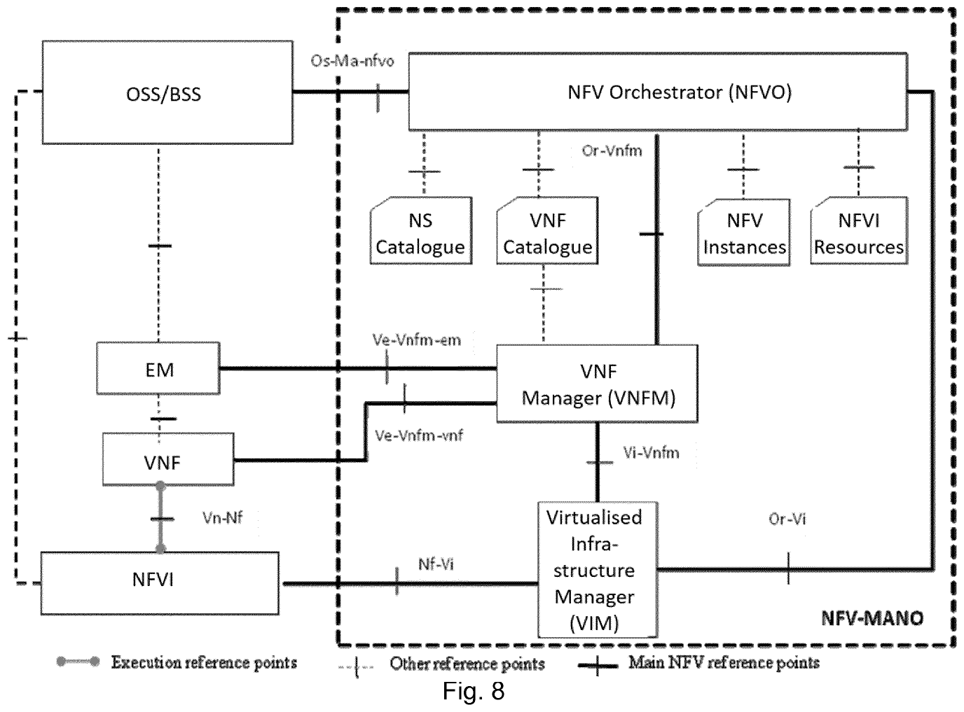

Further, FIG. 8 shows a schematic diagram of an example of a system architecture utilized according to exemplary embodiments of the present invention.

According to exemplary embodiments of the present invention, the operator is allowed to define a set of wrapped (monitored/protected) VNFs in the cloud.

Thereby, existing approaches are significantly extended.

The subsequent operations according to exemplary embodiments of the present invention such as deciding where in the network the monitoring points should be placed, what would be the optimal location in the cloud for instantiating the wrapper VNFs, how the network traffic rules should be updated and how to do the start-up/teardown operations transparently, are handled autonomously by the wrapper management functionality (as part of cloud security director MANO according to some embodiments of the present invention).

According to further exemplary embodiments of the present invention, the functionality of the MANO is extended through the wrapper management entity.

FIG. 3 shows an example scenario of a group of interconnected VNFs in a cloud. These VNFs have both inter-VNF and external network connections.

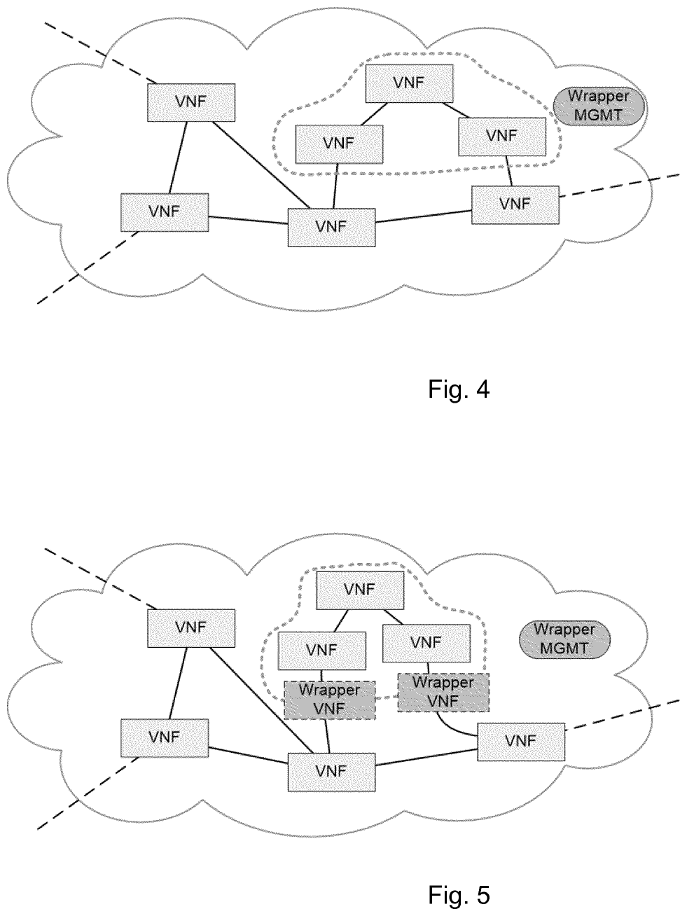

FIG. 4 shows an exemplary wrapping boundary definition around a group of VNFs. This boundary may be defined by the operator directly into the network graph, or the operator can simply define a group of VNFs for wrapping. In the latter case, according to exemplary embodiments of the present invention, the boundary calculation is handled by the wrapper management entity, which has knowledge of the network graph. The latter option provides the advantage that the operator is enabled to consider the cloud environment on a higher level without intimate concern for the potentially complex interconnections of the VNFs.

According to exemplary embodiments of the present invention, there is an entity in MANO responsible for start-up and management and teardown of wrappers, and in network functions virtualization infrastructure (NFVI) there is an entity that manages the wrapper VNFs' communications with the SDN network. Although in the present specification, these different aspects are sometimes handled as being combined into a “wrapper MGMT” element, according to exemplary embodiments of the present invention which are described later in detail, duties are separated between MANO/NFVI in the context of the wrapper management entity.

FIG. 5 shows the logical instantiation of wrapper VNFs according to exemplary embodiments of the present invention at the communications edge of the wrapped VNF aggregate. The wrapper VNFs have full in-line access to the network traffic flowing between the enclosed VNF aggregate and other VNFs. This access enables the wrappers to have a wide range of functionality, which can range from simple passive monitoring to extensive IDS implementations and threat mitigation. The placement of wrapper VNFs can also be optimized with regard to the underlying hardware's processing and bandwidth limitations.

According to some embodiments, in the insertion of flow rules, the wrapper VNFs have no individual IP addresses on user plane, but are simply placed in the communications path by having traffic from an outside VNF output to first wrapper VNF communications interface and then from second wrapper VNF communications interface to the inside VNF, and vice versa, for two-way communications links.

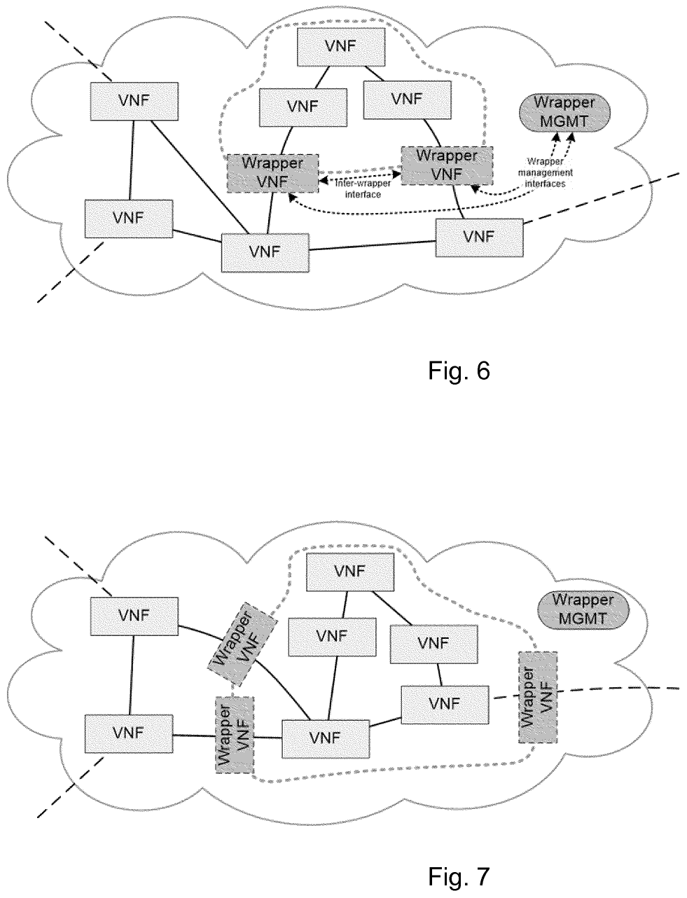

FIG. 6 shows wrapper VNF interconnecting interfaces and management interfaces according to exemplary embodiments of the present invention. Wrapper VNFs are managed by the management entity (potentially cloud security director MANO). This management entails the instantiation and placement of wrapper capabilities and centralized analysis of possibly distributed measurements. In addition the wrapper VNFs can communicate directly with each other, e.g., for sharing detected threat information from a wrapper VNF doing IDS to a wrapper VNF with firewalling capability.

FIG. 7 shows the placement of wrapper VNFs according to exemplary embodiments of the present invention after the boundary of the protected area has been extended to enclose two more VNFs. Again, all the network interfaces connecting the enclosed area with other VNFs/external elements have a wrapper VNF placed into the communications path.

FIG. 8 shows the European Telecommunications Standards Institute (ETSI) network function virtualization (NFV) MANO architecture, which provides context for the message sequence charts according to which exemplary embodiments of the present invention are described in more detail below. In particular, in the following, exemplary details regarding a process of wrapper instantiation, boundary expansion and capability expansion are described.

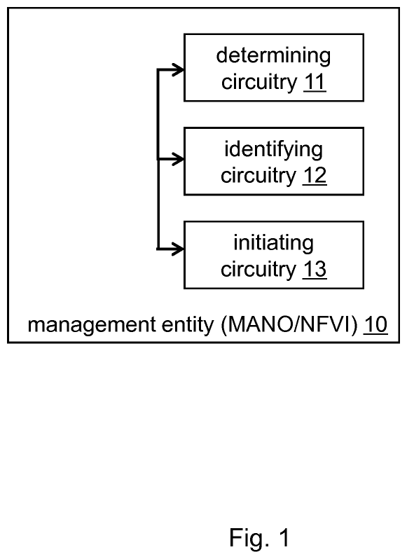

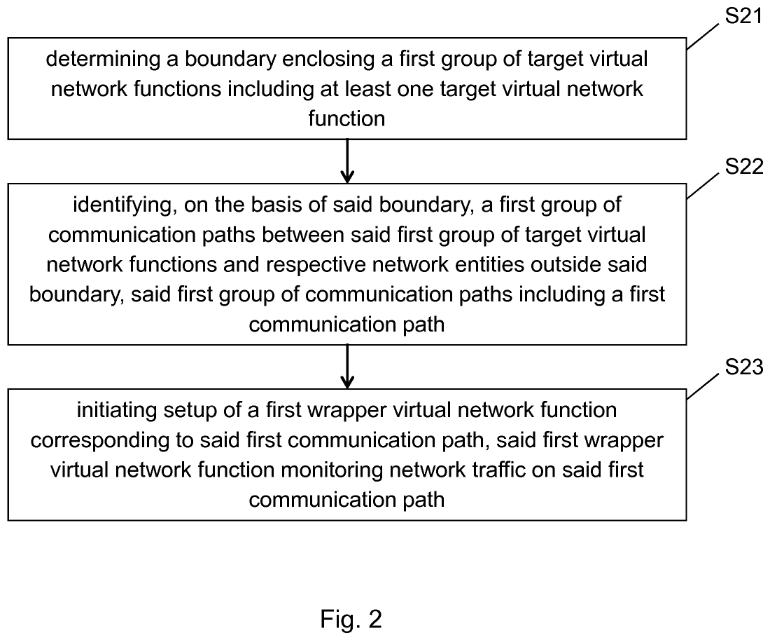

FIG. 1 is a block diagram illustrating an apparatus according to exemplary embodiments of the present invention. The apparatus may be a management entity 10 (in a software defined networking based network) such as a MANO/NFVI comprising a determining circuitry 11, an identifying circuitry 12, and an initiating circuitry 13. The determining circuitry 11 determines a boundary enclosing a first group of target virtual network functions including at least one target virtual network function. The identifying circuitry 12 identifies, on the basis of said boundary, a first group of communication paths between said first group of target virtual network functions and respective network entities outside said boundary, said first group of communication paths including a first communication path. The initiating circuitry 13 initiates setup of a first wrapper virtual network function corresponding to said first communication path, said first wrapper virtual network function monitoring network traffic on said first communication path. FIG. 2 is a schematic diagram of a procedure according to exemplary embodiments of the present invention. The apparatus according to FIG. 1 may perform the method of FIG. 2 but is not limited to this method. The method of FIG. 2 may be performed by the apparatus of FIG. 1 but is not limited to being performed by this apparatus.

As shown in FIG. 2, a procedure according to exemplary embodiments of the present invention comprises an operation of determining (S21) a boundary enclosing a first group of target virtual network functions including at least one target virtual network function, an operation of identifying (S22), on the basis of said boundary, a first group of communication paths between said first group of target virtual network functions and respective network entities outside said boundary, said first group of communication paths including a first communication path, and an operation of initiating (S23) setup of a first wrapper virtual network function corresponding to said first communication path, said first wrapper virtual network function monitoring network traffic on said first communication path.

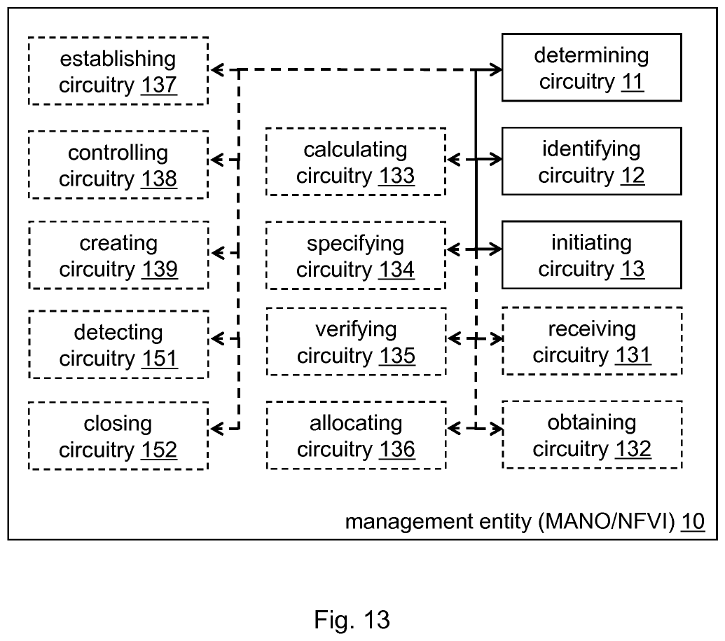

FIG. 13 is a block diagram illustrating an apparatus according to exemplary embodiments of the present invention. In particular, FIG. 13 illustrates a variation of the apparatus shown in FIG. 1. The apparatus according to FIG. 13 may thus further comprise initiating circuitry 131, obtaining circuitry 132, calculating circuitry 133, specifying circuitry 134, verifying circuitry 135, allocating circuitry 136, establishing circuitry 137, controlling circuitry 138, creating circuitry 139, detecting circuitry 151 and/or closing circuitry 152.

In an embodiment at least some of the functionalities of the apparatus shown in FIG. 1 may be shared between at least two physically separate devices or logical entities forming one operational entity. Therefore, the apparatus may be seen to depict the operational entity comprising one or more physically separate devices (or logical entities) for executing at least some of the described processes. Such shared architecture, may exemplarily comprise a separate MANO and a separate NFVI, which are operatively coupled (e.g. via a wireless or wired network) for example.

That is, while for the description of the present level of detail these at least two entities are assumed as being integrated, these may alternatively be not integrated but separated.

According to a variation of the procedure shown in FIG. 2, exemplary details of the determining (S21) operation are given, which are inherently independent from each other as such.

Such exemplary determining (S21) operation according to exemplary embodiments of the present invention may comprise an operation of receiving target virtual network function information indicative of said first group of target virtual network functions, an operation of obtaining information on a network topology of said software defined networking based network, and an operation of calculating said boundary on the basis of said network topology and said target virtual network function information such that said first group of target virtual network functions is enclosed by said boundary.

According to a variation of the procedure shown in FIG. 2, exemplary details of the initiating (S23) operation are given, which are inherently independent from each other as such.

Such exemplary initiating (S23) operation according to exemplary embodiments of the present invention may comprise an operation of specifying resources to be allocated for said first wrapper virtual network function, an operation of verifying availability of said resources to be allocated, and an operation of allocating said first wrapper virtual network function to said resources to be allocated.

According to a variation of the procedure shown in FIG. 2, exemplary additional operations are given, which are inherently independent from each other as such. According to such variation, an exemplary method according to exemplary embodiments of the present invention may comprise an operation of establishing a communication link to said first wrapper virtual network function.

According to a variation of the procedure shown in FIG. 2, exemplary additional operations are given, which are inherently independent from each other as such. According to such variation, an exemplary method according to exemplary embodiments of the present invention may comprise an operation of controlling routing modifications such that said network traffic on said first communication path is routed via said first wrapper virtual network function.

According to a variation of the procedure shown in FIG. 2, exemplary additional operations are given, which are inherently independent from each other as such. According to such variation, said first group of communication paths includes a second communication path, and an exemplary method according to exemplary embodiments of the present invention may comprise an operation of initiating setup of a second wrapper virtual network function corresponding to said second communication path, said second wrapper virtual network function monitoring network traffic on said second communication path, and an operation of establishing a communication link between said first wrapper virtual network function and said second wrapper virtual network function.

According to exemplary embodiments of the present invention, said first wrapper virtual network function is configured to monitor network traffic on at least two communication paths including said first communication path out of said first group of communication paths.

In other words, according to these exemplary embodiments of the present invention, one wrapper VNF can monitor multiple communication paths simultaneously. As a result, the number of wrapper VNFs related to the first group of target VNFs does not necessarily correspond to the number of communication paths between the first group of target VNFs and network entities outside the boundary. In particular, an arrangement of wrapper VNFs different from “one wrapper VNF per communication path” is possible.

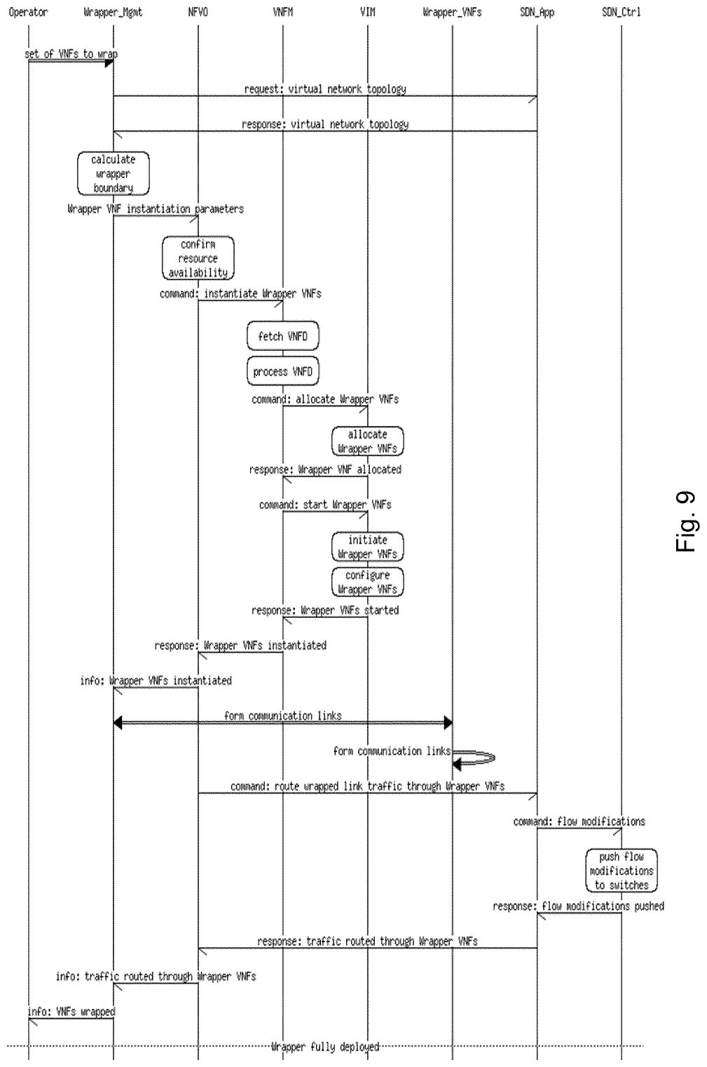

The above explained aspects of a procedure is described in more specific terms with reference to FIG. 9, showing an exemplary wrapper instantiation in the ETSI NFV MANO context (shown in FIG. 8) for the case where the enclosed VNFs are already started up and running prior to wrapping.

As is derivable from FIG. 9, in respect of the wrapper-MGMT, a set of VNFs to be wrapped is received (potentially input by the operator), the virtual network topology is retrieved, based thereon a wrapper boundary is define d/calculated, and the respective wrapper VNF(s) is (are) instantiated based thereon.

Further, out-of-band communication links are formed between the wrapper_MGMT and the respective wrapper VNFs.

Further, respective communication links between the wrapper VNFs are formed.

Further, SDN flow modifications necessary for routing traffic on certain communication links through the wrapper VNFs are effected.

Finally, wrapper activation information is propagated to the operator.

According to a variation of the procedure shown in FIG. 2, exemplary additional operations are given, which are inherently independent from each other as such. According to such variation, an exemplary method according to exemplary embodiments of the present invention may comprise an operation of determining a modified boundary enclosing a second group of target virtual network functions, an operation of identifying, on the basis of said modified boundary, a second group of communication paths between said second group of target virtual network functions and respective network entities outside said boundary, and an operation of creating, on the basis of said first group of communication paths, said second group of communication paths, and wrapper virtual network functions set up for said first group of communication paths, a setup list indicative of at least one wrapper virtual network function to be set up and/or a termination list indicative of at least one wrapper virtual network function out of said wrapper virtual network functions set up for said first group of communication paths to be terminated.

According to a variation of the procedure shown in FIG. 2, exemplary additional operations are given, which are inherently independent from each other as such. According to such variation, an exemplary method according to exemplary embodiments of the present invention may comprise an operation of initiating setup of said at least one wrapper virtual network function to be set up on the basis of said setup list.

According to such variation, an exemplary method according to exemplary embodiments of the present invention may also comprise an operation of initiating termination of said at least one wrapper virtual network function to be terminated on the basis of said termination list.

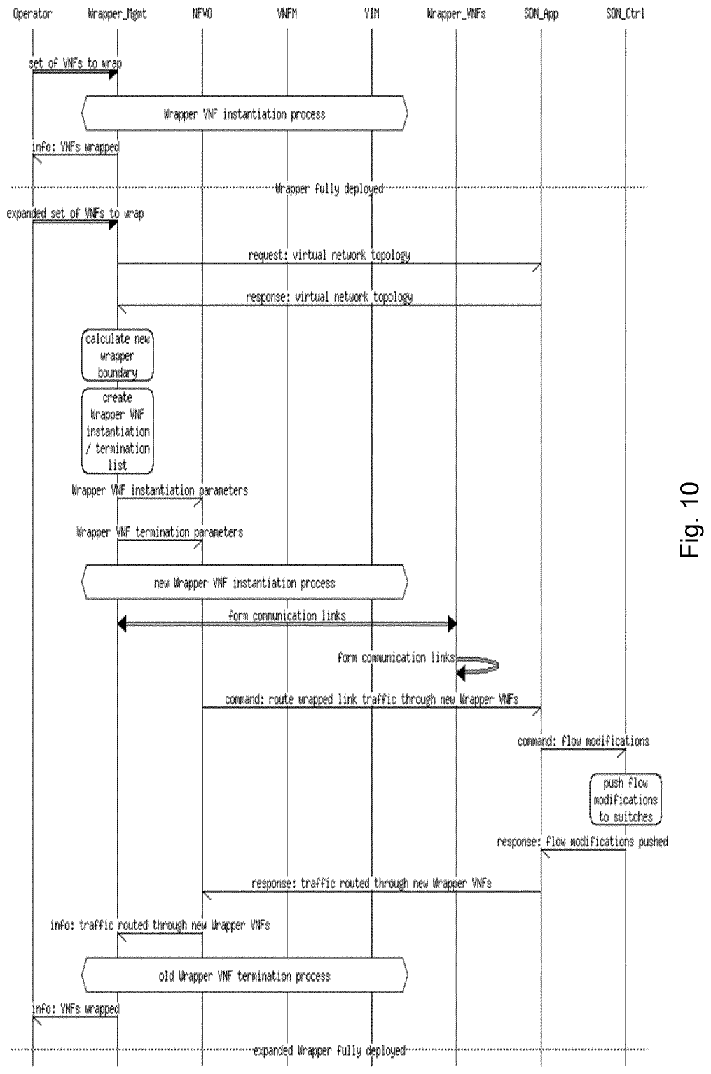

The above explained aspects of a procedure is described in more specific terms with reference to FIG. 10, showing an exemplary wrapper boundary expansion process.

As is derivable from FIG. 10, first the original Wrapper is (already) deployed as described with reference to FIG. 9.

After such deployment, in the present case, there is an expansion regarding the set of VNFs that should be wrapped.

Wrapper_MGMT calculates the new boundary in the virtual network topology and sets up instantiation of new wrapper VNFs (if any) and sets up termination of unnecessary wrapper VNFs (if any). Traffic in/out of the wrapped area is first routed through the new set of wrapper VNFs and then the old wrapper VNFs (if any) are terminated.

It is noted that wrapper VNFs can also be dynamically repurposed, i.e. the same running VNF can be moved to intercept traffic on another communications link instead of instantiating an identical VNF and terminating the old one.

According to a variation of the procedure shown in FIG. 2, exemplary additional operations are given, which are inherently independent from each other as such. According to such variation, an exemplary method according to exemplary embodiments of the present invention may comprise an operation of detecting necessity of a specific ability of said first wrapper virtual network function, and an operation of initiating setup of an expansion wrapper virtual network function corresponding to said first communication path, said expansion wrapper virtual network function being equipped with said specific ability.

It is noted in this regard that in case the first wrapper virtual network function monitors network traffic on at least two communication paths including said first communication path out of said first group of communication paths, setup of an expansion wrapper virtual network function corresponding to each of the at least two communication paths including said first communication path may be initiated.

According to a variation of the procedure shown in FIG. 2, exemplary additional operations are given, which are inherently independent from each other as such. According to such variation, an exemplary method according to exemplary embodiments of the present invention may comprise an operation of establishing a communication link to said expansion wrapper virtual network function, an operation of establishing a communication link between said first wrapper virtual network function and said expansion wrapper virtual network function, and an operation of controlling routing modifications such that said network traffic on said first communication path is routed via said expansion wrapper virtual network function.

It is noted in this regard that in case the first wrapper virtual network function monitors network traffic on at least two communication paths including said first communication path out of said first group of communication paths, routing modifications may be controlled such that said network traffic on the at least two communication paths including said first communication path is routed via said expansion wrapper virtual network function.

According to a variation of the procedure shown in FIG. 2, exemplary additional operations are given, if said expansion wrapper virtual network function includes all abilities of said first wrapper virtual network function, which are inherently independent from each other as such. According to such variation, an exemplary method according to exemplary embodiments of the present invention may comprise an operation of establishing a communication link to said expansion wrapper virtual network function, an operation of controlling routing modifications such that said network traffic on said first communication path is routed via said expansion wrapper virtual network function and such that said network traffic on said first communication path is not routed via said first wrapper virtual network function, and an operation of initiating termination of said first wrapper virtual network function.

It is noted in this regard that in case the first wrapper virtual network function monitors network traffic on at least two communication paths including said first communication path out of said first group of communication paths, routing modifications may be controlled such that said network traffic on the at least two communication paths including said first communication path is routed via said expansion wrapper virtual network function and such that the at least two communication paths including said first communication path is not routed via said first wrapper virtual network function.

According to a variation of the procedure shown in FIG. 2, said necessity is detected based on a receipt of information regarding detection of suspicious traffic pattern in relation to said first communication path monitored by said first wrapper virtual network function.

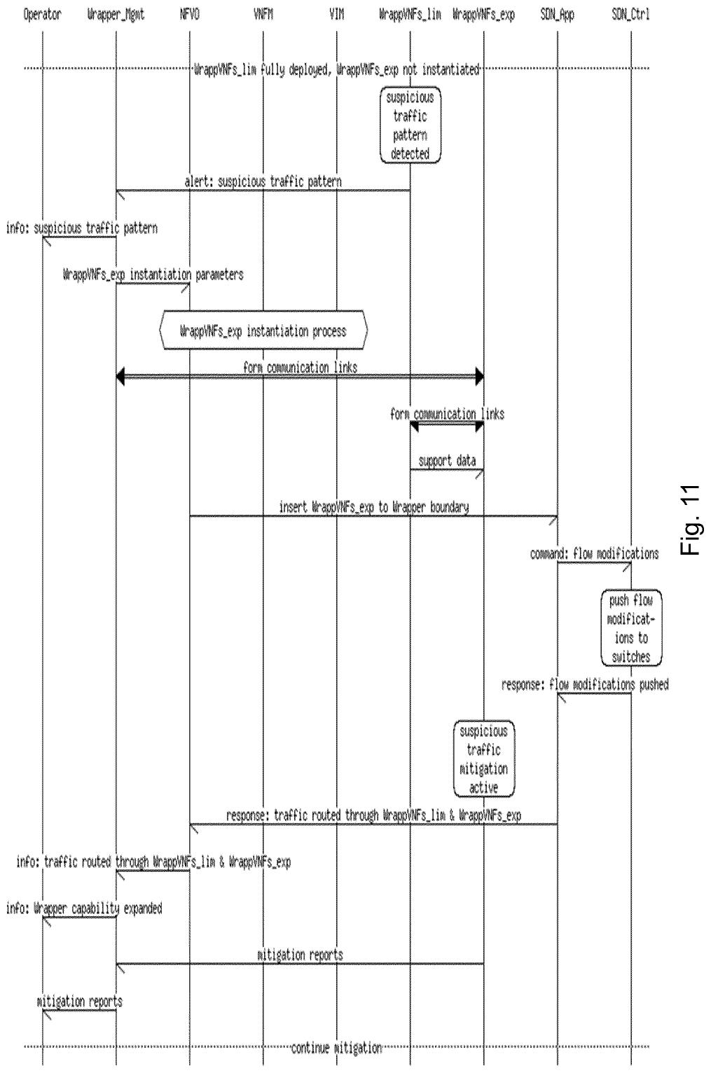

The above explained aspects of a procedure is described in more specific terms with reference to FIG. 11, showing an exemplary wrapper capability expansion.

As is derivable from FIG. 11, in the starting state, a limited wrapper VNF is running using a small amount of resources, e.g., doing simple traffic profiling.

After the limited wrapper VNF for example detects an anomaly in the traffic, it alerts the wrapper management, which decides to start the instantiation of an expanded-functionality wrapper VNF.

This expanded-functionality wrapper VNF is then placed in-line with the limited wrapper VNF, and they operate together to analyze and mitigate the potentially malicious traffic.

It is noted that the limited wrapper VNF can be terminated if the expanded-functionality wrapper VNF provides all of the limited wrapper VNF's functionality.

According to a variation of the procedure shown in FIG. 2, exemplary additional operations are given, which are inherently independent from each other as such. According to such variation, an exemplary method according to exemplary embodiments of the present invention may comprise an operation of receiving termination target virtual network function information indicative of that wrapper virtual network functions in relation to a third group of target virtual network functions are to be terminated, an operation of identifying said wrapper virtual network functions in relation to said third group of target virtual network functions, and an operation of initiating termination of each of said wrapper virtual network functions in relation to said third group of target virtual network functions.

The third group is a group of target virtual network functions for which at least one wrapper virtual network function monitoring network traffic on communication paths between said third group of target virtual network functions and respective network entities outside a boundary enclosing said third group of target virtual network functions is operated. In other words, the third group may for example be a group corresponding to the first group of target virtual network functions mentioned above, for which (at least) the first wrapper virtual network function is set up. Further, the third group may for example be a group corresponding to the second group of target virtual network functions mentioned above, which is enclosed by an expanded (modified) wrapper boundary as discussed above. The third group, however, is not limited to these examples.

According to a variation of the procedure shown in FIG. 2, exemplary details of the initiating operation (initiating termination of each of said wrapper virtual network functions in relation to said third group of target virtual network functions) are given, which are inherently independent from each other as such.

Such exemplary initiating operation according to exemplary embodiments of the present invention may comprise an operation of retrieving monitoring information of said wrapper virtual network functions in relation to said third group of target virtual network functions, an operation of closing respective communication links to said wrapper virtual network functions in relation to said third group of target virtual network functions, and an operation of closing respective communication links between said wrapper virtual network functions in relation to said third group of target virtual network functions.

According to a variation of the procedure shown in FIG. 2, exemplary details of the initiating operation (initiating termination of each of said wrapper virtual network functions in relation to said third group of target virtual network functions) are given, which are inherently independent from each other as such.

Such exemplary initiating operation according to exemplary embodiments of the present invention may comprise an operation of controlling routing modifications such that said network traffic on communication paths in relation to said third group of target virtual network functions is not routed via said wrapper virtual network functions in relation to said third group of target virtual network functions.

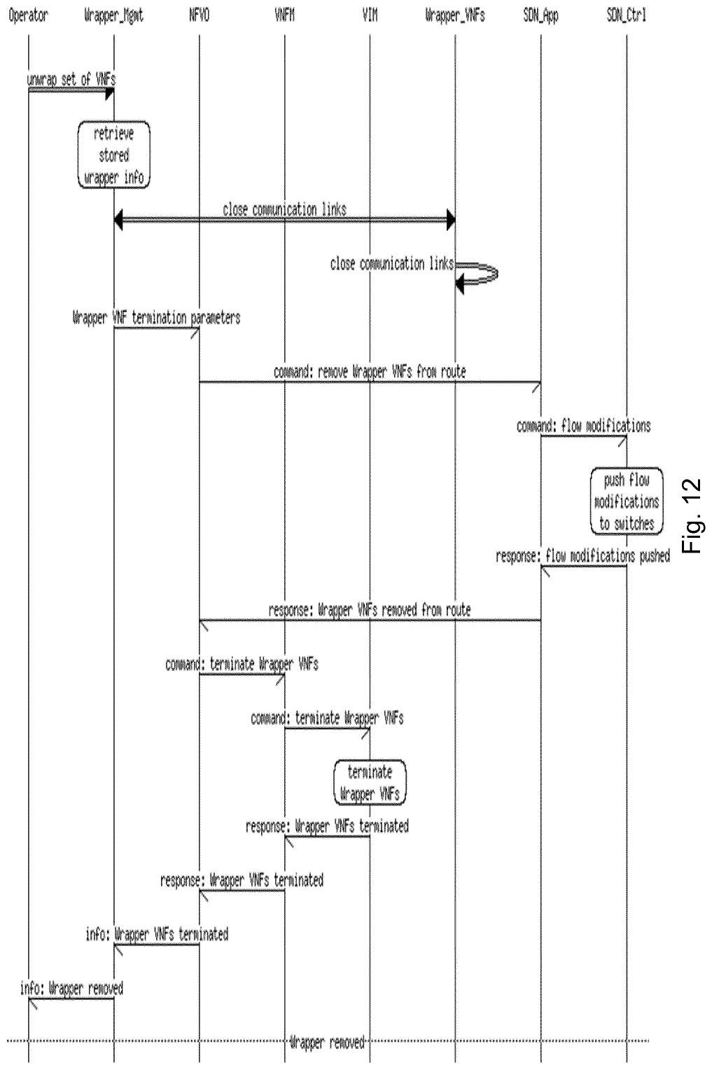

The above explained aspects of a procedure is described in more specific terms with reference to FIG. 12, showing an exemplary wrapper termination process in a case where the operator removes the wrapping around a complete set of wrapped VNFs.

As is derivable from FIG. 12, the process is largely the reverse of the wrapping operation. Firstly, communications links with and between the wrapper VNFs are closed gracefully. Subsequently, the wrapper VNFs are removed from the communications paths. Finally, the wrapper VNF instances are terminated.

According to exemplary embodiments, a system (or apparatus or compound of apparatuses) and a method for wrapping the network communications interfaces of groups of VNFs at runtime is provided. Particular measures, properties and effects of exemplary embodiments of the present invention are the ability to select a VNF or a group of VNFs to be wrapped, the deduction of desirable monitoring points, the introduction of wrapper VNFs at monitoring points, the coordination of these wrapper VNFs, the interaction of these wrapper VNFs with wrapper management (e.g. MANO), the ability to dynamically adjust the wrapper boundary at runtime, the ability to dynamically adjust the capabilities of the wrapper VNFs, and/or the ability to transparently tear-down the wrapping elements and return to the original state.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not construed to limit the invention, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

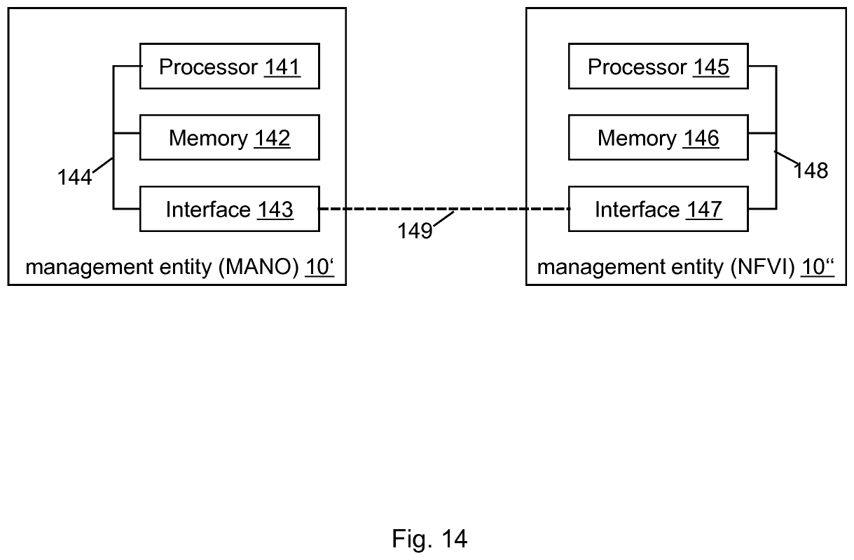

In FIG. 14, an alternative illustration of apparatuses according to exemplary embodiments of the present invention is depicted. As indicated in FIG. 14, according to exemplary embodiments of the present invention, the apparatus (management entity) 10′ and 10″ (corresponding to the management entity 10) comprises a processor 141, 145, a memory 142, 146 and an interface 143, 147, which are connected by a bus 144, 148 or the like, and the functionality of the management entity 10′ and 10″ may be integrated or distributed to several physical and/or logical entities. If distributed to several physical and/or logical entities, the respective entities (e.g. 10′ and 10″ may be connected via link 149, respectively).

The processor 141/145 and/or the interface 143/147 may also include a modem or the like to facilitate communication over a (hardwire or wireless) link, respectively. The interface 143/147 may include a suitable transceiver coupled to one or more antennas or communication means for (hardwire or wireless) communications with the linked or connected device(s), respectively. The interface 143/147 is generally configured to communicate with at least one other apparatus, i.e. the interface thereof.

The memory 142/146 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the management entity 10′, 10″ comprises at least one processor 141/145, at least one memory 142/146 including computer program code, and at least one interface 143/147 configured for communication with at least another apparatus. The processor (i.e. the at least one processor 141/145, with the at least one memory 142/146 and the computer program code) is configured (in an integrated or distributed manner) to perform determining a boundary enclosing a first group of target virtual network functions including at least one target virtual network function (thus the apparatus comprising corresponding means for determining), to perform identifying, on the basis of said boundary, a first group of communication paths between said first group of target virtual network functions and respective network entities outside said boundary, said first group of communication paths including a first communication path (thus the apparatus comprising corresponding means for identifying), and to perform initiating setup of a first wrapper virtual network function corresponding to said first communication path, said first wrapper virtual network function monitoring network traffic on said first communication path (thus the apparatus comprising corresponding means for initiating).

For further details regarding the operability/functionality of the individual apparatuses, reference is made to the above description in connection with any one of FIGS. 1 to 13, respectively.

For the purpose of the present invention as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for malicious network activity mitigation. Such measures exemplarily comprise determining a boundary enclosing a first group of target virtual network functions including at least one target virtual network function, identifying, on the basis of said boundary, a first group of communication paths between said first group of target virtual network functions and respective network entities outside said boundary, said first group of communication paths including a first communication path, and initiating setup of a first wrapper virtual network function corresponding to said first communication path, said first wrapper virtual network function monitoring network traffic on said first communication path.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

DDoS distributed denial of service

DoS denial of service

DPI deep packet inspection

ETSI European Telecommunications Standards Institute

IDS intrusion detection system

MANO management and orchestration

NFV network function virtualization

NFVI network functions virtualization infrastructure

SDN software defined networking

VNF virtual network function

VNFI virtual network function interface

1. A method in a software defined networking based network, comprising:
determining a boundary enclosing a first group of target virtual network functions including at least one target virtual network function,
identifying, on the basis of said boundary, a first group of communication paths between said first group of target virtual network functions and respective network entities outside said boundary, said first group of communication paths including a first communication path, and
initiating setup of a first wrapper virtual network function corresponding to said first communication path, said first wrapper virtual network function monitoring network traffic on said first communication path.

2-16. (canceled)

17. An apparatus in a software defined networking based network, the apparatus comprising:
at least one processor; and
at least one memory including computer program code;
the at least one memory and the computer program code configured to, with the at least one processor, cause the apparatus at least to
determine a boundary enclosing a first group of target virtual network functions including at least one target virtual network function,
identify, on the basis of said boundary, a first group of communication paths between said first group of target virtual network functions and respective network entities outside said boundary, said first group of communication paths including a first communication path, and
initiate setup of a first wrapper virtual network function corresponding to said first communication path, said first wrapper virtual network function monitoring network traffic on said first communication path.

18. The apparatus according to claim 17, wherein said at least one memory and computer program code are further configured to cause the apparatus to
receive target virtual network function information indicative of said first group of target virtual network functions,
obtain information on a network topology of said software defined networking based network, and
calculate said boundary on the basis of said network topology and said target virtual network function information such that said first group of target virtual network functions is enclosed by said boundary.

19. The apparatus according to claim 17, wherein said at least one memory and computer program code are further configured to cause the apparatus to
specify resources to be allocated for said first wrapper virtual network function,
verify availability of said resources to be allocated, and
allocate said first wrapper virtual network function to said resources to be allocated.

20. The apparatus according to claim 17, wherein said at least one memory and computer program code are further configured to cause the apparatus to
establish a communication link to said first wrapper virtual network function.

21. The apparatus according to claim 17, wherein said at least one memory and computer program code are further configured to cause the apparatus to
control routing modifications such that said network traffic on said first communication path is routed via said first wrapper virtual network function.

22. The apparatus according to claim 17, wherein
said first group of communication paths includes a second communication path, and
wherein said at least one memory and computer program code are further configured to cause the apparatus to
initiate setup of a second wrapper virtual network function corresponding to said second communication path, said second wrapper virtual network function monitoring network traffic on said second communication path, and
establish a communication link between said first wrapper virtual network function and said second wrapper virtual network function.

23. The apparatus according to claim 17, wherein
said first wrapper virtual network function is configured to monitor network traffic on at least two communication paths including said first communication path out of said first group of communication paths.

24. The apparatus according to claim 17, wherein said at least one memory and computer program code are further configured to cause the apparatus to
determine a modified boundary enclosing a second group of target virtual network functions,
identify, on the basis of said modified boundary, a second group of communication paths between said second group of target virtual network functions and respective network entities outside said boundary, and
create, on the basis of said first group of communication paths, said second group of communication paths, and wrapper virtual network functions set up for said first group of communication paths, a setup list indicative of at least one wrapper virtual network function to be set up or a termination list indicative of at least one wrapper virtual network function out of said wrapper virtual network functions set up for said first group of communication paths to be terminated.

25. The apparatus according to claim 24, wherein said at least one memory and computer program code are further configured to cause the apparatus to
initiate setup of said at least one wrapper virtual network function to be set up on the basis of said setup list, or
initiate termination of said at least one wrapper virtual network function to be terminated on the basis of said termination list.

26. The apparatus according to claim 17, wherein said at least one memory and computer program code are further configured to cause the apparatus to
detect necessity of a specific ability of said first wrapper virtual network function, and
initiate setup of an expansion wrapper virtual network function corresponding to said first communication path, said expansion wrapper virtual network function being equipped with said specific ability.

27. The apparatus according to claim 26, wherein said at least one memory and computer program code are further configured to cause the apparatus to
establish a communication link to said expansion wrapper virtual network function,
establish a communication link between said first wrapper virtual network function and said expansion wrapper virtual network function, and
control routing modifications such that said network traffic on said first communication path is routed via said expansion wrapper virtual network function.

28. The apparatus according to claim 26, wherein said at least one memory and computer program code are further configured to cause the apparatus to
establish, if said expansion wrapper virtual network function includes all abilities of said first wrapper virtual network function, a communication link to said expansion wrapper virtual network function, control, if said expansion wrapper virtual network function includes all abilities of said first wrapper virtual network function, routing modifications such that said network traffic on said first communication path is routed via said expansion wrapper virtual network function and such that said network traffic on said first communication path is not routed via said first wrapper virtual network function, and
initiate, if said expansion wrapper virtual network function includes all abilities of said first wrapper virtual network function, termination of said first wrapper virtual network function.

29. The apparatus according to claim 26, wherein
said necessity is detected based on a receipt of information regarding detection of suspicious traffic pattern in relation to said first communication path monitored by said first wrapper virtual network function.

30. The apparatus according to claim 17, wherein said at least one memory and computer program code are further configured to cause the apparatus to
receive termination target virtual network function information indicative of that wrapper virtual network functions in relation to a third group of target virtual network functions are to be terminated, said third group being a group of target virtual network functions for which at least one wrapper virtual network function monitoring network traffic on communication paths between said third group of target virtual network functions and respective network entities outside a boundary enclosing said third group of target virtual network functions is operated,
identify said wrapper virtual network functions in relation to said third group of target virtual network functions, and
initiate termination of each of said wrapper virtual network functions in relation to said third group of target virtual network functions.

31. The apparatus according to claim 30, wherein said at least one memory and computer program code are further configured to cause the apparatus to
receive monitoring information of said wrapper virtual network functions in relation to said third group of target virtual network functions,
close respective communication links to said wrapper virtual network functions in relation to said third group of target virtual network functions, and
close respective communication links between said wrapper virtual network functions in relation to said third group of target virtual network functions.

32. The apparatus according to claim 31, wherein said at least one memory and computer program code are further configured to cause the apparatus to
control routing modifications such that said network traffic on communication paths in relation to said third group of target virtual network functions is not routed via said wrapper virtual network functions in relation to said third group of target virtual network functions.

33. (canceled)

34. A computer program product embodied on a non-transitory computer-readable medium, said product comprising computer-executable computer program code which, when the program is run on a computer, is configured to cause the computer to carry out the method according to claim 1.

35. (canceled)
